(19) United States
(12) Patent Application Publication
(10) Pub. No.: US 2020/0027189 A1
(43) Pub. Date: Jan. 23, 2020

(54) EFFICIENT DEPENDENCY DETECTION FOR CONCURRENT BINNING GPU WORKLOADS

(71) Applicant: QUALCOMM Incorporated, San Diego, CA (US)

(72) Inventors: Jonnala Gadda Nagendra Kumar, San Diego, CA (US); Andrew Yelder, New York, NY (US); Jian Liang, San Diego, CA (US); Avinash Seetharamaiah, San Diego, CA (US)

(21) Appl. No.: 16/042,172

(22) Filed: Jul. 23, 2018

(51) Int. Cl. G06T 1/20; G06F 9/50; G06F 9/48

(52) U.S. Cl. CPC G06T 1/20; G06F 9/5016; G06F 9/4881; G06F 9/505

(57) ABSTRACT

Methods, systems, and devices for dependency detection of a graphical processor unit (GPU) workload at a device are described. The method relates to generating a resource packet for a first GPU workload of a set of GPU workloads, the resource packet including a list of resources, identifying a first resource from the list of resources, retrieving a GPU address from a first memory location associated with the first resource, determining whether a dependency of the first resource exists between the first GPU workload and a second GPU workload from the set of GPU workloads based on the retrieving of the GPU address, and processing, when the dependency exists, the first resource after waiting for a duration to lapse.

### BACKGROUND

The following relates generally to rendering, and more specifically to dependency detection of a graphical processor unit (GPU) workload at a device.

A device that provides content for visual presentation on an electronic display may include a processor. One type of processor is a GPU. The processor in conjunction with other components renders pixels that are representative of the content on the display. That is, the processor generates one or more pixel values for each pixel on the display and performs graphics processing on the pixel values for each pixel on the display to render each pixel for presentation.

For example, the processor may convert two-dimensional or three-dimensional virtual objects into a two-dimensional pixel representation that may be displayed. Converting information about three-dimensional objects into information that can be displayed may require considerable memory and processing power. Three-dimensional graphics accelerators are becoming increasingly available in devices such as personal computers, smartphones, tablet computers, etc. Such devices may in some cases have constraints on computational power, memory capacity, and/or other parameters. Accordingly, three-dimensional graphics rendering techniques may present difficulties when being implemented on these devices. Improved rendering techniques may be desired.

### SUMMARY

The described techniques relate to improved methods, systems, devices, and apparatuses that support efficient dependency detection for concurrent binning processor workloads. Generally, the described techniques provide for dependency detection of a graphical processor unit (GPU) workload at a device.

A method of dependency detection of a GPU workload at a device is described. The method may include generating a resource packet for a first GPU workload of a set of GPU workloads, the resource packet including a list of resources, identifying a first resource from the list of resources, retrieving a GPU address from a first memory location associated with the first resource, determining whether a dependency of the first resource exists between the first GPU workload and a second GPU workload from the set of GPU workloads based on the retrieving of the GPU address, and processing, when the dependency exists, the first resource after waiting for a duration to lapse.

An apparatus for dependency detection of a graphical processor unit (GPU) workload at a device is described. The apparatus may include a processor, memory in electronic communication with the processor, and instructions stored in the memory. The instructions may be executable by the processor to cause the apparatus to generate a resource packet for a first GPU workload of a set of GPU workloads, the resource packet including a list of resources, identify a first resource from the list of resources, retrieve a GPU address from a first memory location associated with the first resource, determine whether a dependency of the first resource exists between the first GPU workload and a second GPU workload from the set of GPU workloads based on the retrieving of the GPU address, and process, when the dependency exists, the first resource after waiting for a duration to lapse.

Another apparatus for dependency detection of a graphical processor unit (GPU) workload at a device is described. The apparatus may include means for generating a resource packet for a first GPU workload of a set of GPU workloads, the resource packet including a list of resources, identifying a first resource from the list of resources, retrieving a GPU address from a first memory location associated with the first resource, determining whether a dependency of the first resource exists between the first GPU workload and a second GPU workload from the set of GPU workloads based on the retrieving of the GPU address, and processing, when the dependency exists, the first resource after waiting for a duration to lapse.

A non-transitory computer-readable medium storing code for dependency detection of a graphical processor unit (GPU) workload at a device is described. The code may include instructions executable by a processor to generate a resource packet for a first GPU workload of a set of GPU workloads, the resource packet including a list of resources, identify a first resource from the list of resources, retrieve a GPU address from a first memory location associated with the first resource, determine whether a dependency of the first resource exists between the first GPU workload and a second GPU workload from the set of GPU workloads based on the retrieving of the GPU address, and process, when the dependency exists, the first resource after waiting for a duration to lapse.

Some examples of the method, apparatuses, and non-transitory computer-readable medium described herein may further include operations, features, means, or instructions for processing the first resource without waiting for the duration to lapse when the dependency does not exist.

Some examples of the method, apparatuses, and non-transitory computer-readable medium described herein may further include operations, features, means, or instructions for identifying the first resource as a bindless resource based on the retrieving of the GPU address, where determining whether the dependency of the first resource exists between the first GPU workload and the second GPU workload may be based on the first resource being identified as a bindless resource.

Some examples of the method, apparatuses, and non-transitory computer-readable medium described herein may further include operations, features, means, or instructions for identifying a second resource from the list of resources as a non-bindless resource. Some examples of the method, apparatuses, and non-transitory computer-readable medium described herein may further include operations, features, means, or instructions for identifying a GPU address of the second resource provided in the resource packet and providing the GPU address of the second resource directly to a GPU without waiting for the duration to lapse.

In some examples of the method, apparatuses, and non-transitory computer-readable medium described herein, the list of resources includes a list of read resources and a list of write resources. In some examples of the method, apparatuses, and non-transitory computer-readable medium described herein, the list of resources includes entries for resource descriptors of resources being read or written during the first GPU workload.

In some examples of the method, apparatuses, and non-transitory computer-readable medium described herein, generating the resource packet may include operations, features, means, or instructions for generating the resource packet using a GPU device driver.

Some examples of the method, apparatuses, and non-transitory computer-readable medium described herein may further include operations, features, means, or instructions for determining that a number of resources provided in the first GPU workload satisfies a determined resource threshold, waiting on a current duration and clearing at least one memory location associated with a third GPU workload that finishes before the first GPU workload finishes. In some examples of the method, apparatuses, and non-transitory computer-readable medium described herein, the GPU address includes a pointer to a second memory location containing a base GPU address of the first resource.

In some examples of the method, apparatuses, and non-transitory computer-readable medium described herein, the first memory location, or the second memory location, or both, include a pointer to a third memory location where a countdown value of the duration may be stored. In some examples of the method, apparatuses, and non-transitory computer-readable medium described herein, at least one of the set of GPU workloads includes a concurrent binning GPU workload, or a level 1 indirect buffer (IB1) workload, or both.

Some examples of the method, apparatuses, and non-transitory computer-readable medium described herein may further include operations, features, means, or instructions for generating at least one resource packet for each of the set of GPU workloads.

### BRIEF DESCRIPTION OF THE DRAWINGS

FIG. 1 illustrates an example of a system for dependency detection of a graphical processor unit (GPU) workload at a device that supports efficient dependency detection for concurrent binning GPU workloads in accordance with aspects of the present disclosure.

FIG. 2 illustrates an example of a GPU environment that supports efficient dependency detection for concurrent binning GPU workloads in accordance with aspects of the present disclosure.

FIG. 3 illustrates an example of a GPU environment that supports efficient dependency detection for concurrent binning GPU workloads in accordance with aspects of the present disclosure.

FIG. 4 illustrates an example of a GPU environment that supports efficient dependency detection for concurrent binning GPU workloads in accordance with aspects of the present disclosure.

FIG. 5 illustrates an example of a GPU environment that supports efficient dependency detection for concurrent binning GPU workloads in accordance with aspects of the present disclosure.

FIG. 6 illustrates an example of a GPU environment that supports efficient dependency detection for concurrent binning GPU workloads in accordance with aspects of the present disclosure.

FIG. 7 illustrates an example of a GPU environment that supports efficient dependency detection for concurrent binning GPU workloads in accordance with aspects of the present disclosure.

FIG. 8 illustrates an example of a GPU environment that supports efficient dependency detection for concurrent binning GPU workloads in accordance with aspects of the present disclosure.

FIG. 9 illustrates an example of a GPU environment that supports efficient dependency detection for concurrent binning GPU workloads in accordance with aspects of the present disclosure.

FIGS. 10 and 11 show block diagrams of devices that support efficient dependency detection for concurrent binning GPU workloads in accordance with aspects of the present disclosure.

FIG. 12 shows a block diagram of a GPU that supports efficient dependency detection for concurrent binning GPU workloads in accordance with aspects of the present disclosure.

FIG. 13 shows a diagram of a system including a device that supports efficient dependency detection for concurrent binning GPU workloads in accordance with aspects of the present disclosure.

FIGS. 14 through 16 show flowcharts illustrating methods that support efficient dependency detection for concurrent binning GPU workloads in accordance with aspects of the present disclosure.

### DETAILED DESCRIPTION

The following relates generally to concurrent binning. Specifically, the following relates to efficient dependency detection for concurrent binning GPU workloads.

When executing concurrent binning workloads on a GPU, if a workload has a dependency on some operation running in another workload, it cannot start until that dependency has been met. From the software side, the full information about the dependencies may not be known until the workload is being submitted to the GPU, which makes it difficult to track and detect all the dependencies efficiently.

In order to efficiently detect dependencies of concurrent binning workloads, a component or software can submit a list of read and written resources for a given workload for a given number of passes that could occur in that workload along with a determined time duration for each pass that can be waited on to ensure that the actions in that pass have completed. In some cases, these determined durations of time may be referred to as timestamps or duration timestamps.

When binning workloads are submitted to the GPU (or another processor component), data that the GPU is referencing can no longer be modified from the application side. An example of this data may include resources that are being referenced in an operation (e.g., data read in a read operation and/or data written in a write operation).

In order to efficiently detect dependencies of concurrent binning workloads, the present systems and methods may submit a list of data read and/or data write resources for a given workload for a given number of passes that may occur in that workload, together with a determined time duration for each pass that may be waited on to ensure that the actions in that pass have completed. One advantage of this solution is reduced driver overhead while also reducing bubbles (e.g., rendering delays) that can occur from components or software performing inefficient stalls to satisfy dependencies.

In some cases, the present techniques may include increasing a granularity of lists and durations, so that a list and determined duration are generated for both Render and Visual (Viz) pass per workload. In one example, a Stream Out (SO) write to resource A (Res A) may finish in Viz pass of workload 0 and Viz pass of workload 1 may read from Res A as Vertex Buffer (VB). Without the increased granularity, there would be a bubble between Viz pass of workload 0 until all resource operations of workload 0 are complete. Accordingly, the present techniques reduce the number of false positives and enable more accurate operations. Thus, if a read occurs in the render pass of workload 1, the read operation will not affect what hazards are being detected for running Viz pass of workload 0 concurrently.

With concurrent binning, multiple frames or workloads (e.g., level 1 indirect buffers (IB1s), level 2 indirect buffers (IB2s), etc.) may be launched concurrently or simultaneously with the binning pass running ahead of the rendering passes. However, in some case there may be dependencies between the binning/render passes that need to be handled for concurrency between workloads to occur. In some systems, this is handled in old APIs (openGL ES/DX11) in a driver at the cost of driver overhead. But with new APIs (such as DX12/Vulkan), handling these dependencies is difficult or nearly impossible since the descriptors may be bindless. Hence the described techniques handle the new APIs and any lack of handling dependencies by pushing the dependency check on to a command processor of a GPU (e.g., command processor 150) rather than a driver (e.g. GPU driver 120), thus reducing overhead of a host central processor unit (CPU).

In one example, hardware command processor packets may be provided for describing read/write resources per pass (binning/render), as well as also one or more determined duration times per pass. In some cases, a driver (e.g., GPU driver 120) may generate one or more command processor packets for each IB1 to describe the resources being read/written per pass. The command processor packets may be generated because the actual descriptor for the bindless resources may not be known by the driver while generating the IB1/IB2. In some cases, an “indirect address” mode may be used with bindless resources, where a memory location contains the address where the descriptor is written. In some cases, the command processor may wait the duration of an associated determined time duration before referencing the address where the descriptor is written.

On submission, the command processor may compare the read/write resources per pass (either render to binning, render to render, or binning to render) and determine whether a dependency exists. When a dependency does exist, the command processor may wait for the respective duration (e.g. an associated determined time duration) to finish and then proceed with the processing of the workload. Thus, while one approach involves a driver handling the dependency check, the present techniques include configuring a command processor to handle the dependency check in connection with a driver generating the command processor packets.

Aspects of the disclosure are initially described in the context of a GPU environment. Aspects of the disclosure are further illustrated by and described with reference to apparatus diagrams, system diagrams, and flowcharts that relate to efficient dependency detection for concurrent binning GPU workloads.

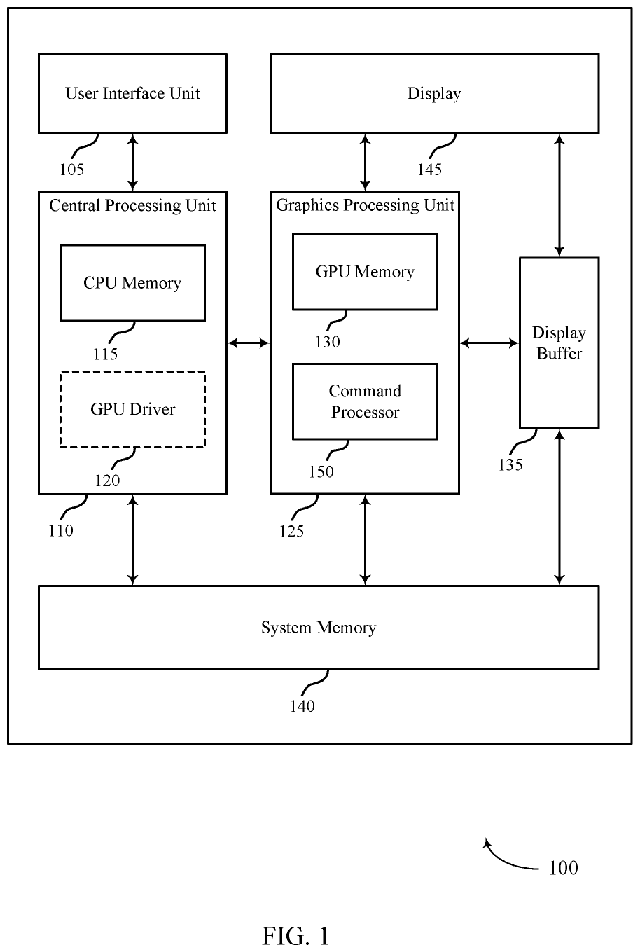

FIG. 1 illustrates an example of a device 100 that supports efficient dependency detection for concurrent binning GPU workloads in accordance with aspects of the present disclosure. Examples of device 100 include, but are not limited to, wireless devices, mobile or cellular telephones, including smartphones, personal digital assistants (PDAs), video gaming consoles that include video displays, mobile video gaming devices, mobile video conferencing units, laptop computers, desktop computers, televisions set-top boxes, tablet computing devices, e-book readers, fixed or mobile media players, and the like.

In the example of FIG. 1, device 100 includes a central processing unit (CPU) 110 having CPU memory 115, a GPU 125 having GPU memory 130 and command processor 150, a display 145, a display buffer 135 storing data associated with rendering, a user interface unit 105, and a system memory 140. For example, system memory 140 may store a GPU driver 120 (illustrated as being contained within CPU 110 as described below) having a compiler, a GPU program, a locally-compiled GPU program, and the like. User interface unit 105, CPU 110, GPU 125, system memory 140, and display 145 may communicate with each other (e.g., using a system bus).

Examples of CPU 110 include, but are not limited to, a digital signal processor (DSP), general purpose microprocessor, application specific integrated circuit (ASIC), field programmable logic array (FPGA), or other equivalent integrated or discrete logic circuitry. Although CPU 110 and GPU 125 are illustrated as separate units in the example of FIG. 1, in some examples, CPU 110 and GPU 125 may be integrated into a single unit. CPU 110 may execute one or more software applications. Examples of the applications may include operating systems, word processors, web browsers, e-mail applications, spreadsheets, video games, audio and/or video capture, playback or editing applications, or other such applications that initiate the generation of image data to be presented via display 145. As illustrated, CPU 110 may include CPU memory 115. For example, CPU memory 115 may represent on-chip storage or memory used in executing machine or object code. CPU memory 115 may include one or more volatile or non-volatile memories or storage devices, such as flash memory, a magnetic data media, an optical storage media, etc. CPU 110 may be able to read values from or write values to CPU memory 115 more quickly than reading values from or writing values to system memory 140, which may be accessed, e.g., over a system bus.

GPU 125 may represent one or more dedicated processors for performing graphical operations. That is, for example, GPU 125 may be a dedicated hardware unit having fixed function and programmable components for rendering graphics and executing GPU applications. GPU 125 may also include a DSP, a general purpose microprocessor, an ASIC, an FPGA, or other equivalent integrated or discrete logic circuitry. GPU 125 may be built with a highly-parallel structure that provides more efficient processing of complex graphic-related operations than CPU 110. For example, GPU 125 may include a plurality of processing elements that are configured to operate on multiple vertices or pixels in a parallel manner. The highly parallel nature of GPU 125 may allow GPU 125 to generate graphic images (e.g., graphical user interfaces and two-dimensional or three-dimensional graphics scenes) for display 145 more quickly than CPU 110.

GPU 125 may, in some instances, be integrated into a motherboard of device 100. In other instances, GPU 125 may be present on a graphics card that is installed in a port in the motherboard of device 100 or may be otherwise incorporated within a peripheral device configured to interoperate with device 100. As illustrated, GPU 125 may include GPU memory 130 and command processor 150. In one example, GPU memory 130 may represent on-chip storage or memory used in executing machine or object code. GPU memory 130 may include one or more volatile or non-volatile memories or storage devices, such as flash memory, a magnetic data media, an optical storage media, etc. GPU 125 may be able to read values from or write values to GPU memory 130 more quickly than reading values from or writing values to system memory 140, which may be accessed, e.g., over a system bus. That is, GPU 125 may read data from and write data to GPU memory 130 without using the system bus to access off-chip memory. This operation may allow GPU 125 to operate in a more efficient manner by reducing the need for GPU 125 to read and write data via the system bus, which may experience heavy bus traffic.

In some examples, command processor 150 may be a first interface between the GPU 125 and a component external to GPU 125. In some cases, command processor 150 may be configured to perform command and stream fetching, state control, and/or register management. In some examples, command processor 150 may include separate queues for commands, streams, and/or kernels. In some cases, command processor 150 may include direct memory access (DMA) for streams and interrupt control unit. In one example, command processor 150 may be configured to send interrupts to a host of GPU 125 (e.g., device 100).

Display 145 represents a unit capable of displaying video, images, text or any other type of data for consumption by a viewer. Display 145 may include a liquid-crystal display (LCD), a light emitting diode (LED) display, an organic LED (OLED), an active-matrix OLED (AMOLED), or the like. Display buffer 135 represents a memory or storage device dedicated to storing data for presentation of imagery, such as computer-generated graphics, still images, video frames, or the like for display 145. Display buffer 135 may represent a two-dimensional buffer that includes a plurality of storage locations. The number of storage locations within display buffer 135 may, in some cases, generally correspond to the number of pixels to be displayed on display 145. For example, if display 145 is configured to include 640×480 pixels, display buffer 135 may include 640×480 storage locations storing pixel color and intensity information, such as red, green, and blue pixel values, or other color values. Display buffer 135 may store the final pixel values for each of the pixels processed by GPU 125. Display 145 may retrieve the final pixel values from display buffer 135 and display the final image based on the pixel values stored in display buffer 135.

User interface unit 105 represents a unit with which a user may interact with or otherwise interface to communicate with other units of device 100, such as CPU 110. Examples of user interface unit 105 include, but are not limited to, a trackball, a mouse, a keyboard, and other types of input devices. User interface unit 105 may also be, or include, a touch screen and the touch screen may be incorporated as part of display 145.

System memory 140 may comprise one or more computer-readable storage media. Examples of system memory 140 include, but are not limited to, a random access memory (RAM), static RAM (SRAM), dynamic RAM (DRAM), a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. System memory 140 may store program modules and/or instructions that are accessible for execution by CPU 110. Additionally, system memory 140 may store user applications and application surface data associated with the applications. System memory 140 may in some cases store information for use by and/or information generated by other components of device 100. For example, system memory 140 may act as a device memory for GPU 125 and may store data to be operated on by GPU 125 (e.g., in a direct rendering operation) as well as data resulting from operations performed by GPU 125.

In some examples, system memory 140 may include instructions that cause CPU 110 or GPU 125 to perform the functions ascribed to CPU 110 or GPU 125 in aspects of the present disclosure. System memory 140 may, in some examples, be considered as a non-transitory storage medium. The term “non-transitory” should not be interpreted to mean that system memory 140 is non-movable. As one example, system memory 140 may be removed from device 100 and moved to another device. As another example, a system memory substantially similar to system memory 140 may be inserted into device 100. In certain examples, a non-transitory storage medium may store data that can, over time, change (e.g., in RAM).

System memory 140 may store a GPU driver 120 and compiler, a GPU program, and a locally-compiled GPU program. The GPU driver 120 may represent a computer program or executable code that provides an interface to access GPU 125. CPU 110 may execute the GPU driver 120 or portions thereof to interface with GPU 125 and, for this reason, GPU driver 120 is shown in the example of FIG. 1 within CPU 110. GPU driver 120 may be accessible to programs or other executables executed by CPU 110, including the GPU program stored in system memory 140. Thus, when one of the software applications executing on CPU 110 requires graphics processing, CPU 110 may provide graphics commands and graphics data to GPU 125 for rendering to display 145 (e.g., via GPU driver 120).

The GPU program may include code written in a high level (HL) programming language, e.g., using an application programming interface (API). Examples of APIs include Open Graphics Library (“OpenGL”), DirectX, Render-Man, WebGL, or any other public or proprietary standard graphics API. The instructions may also conform to so-called heterogeneous computing libraries, such as Open-Computing Language (“OpenCL”), DirectCompute, etc. In general, an API may include a determined, standardized set of commands that are executed by associated hardware. API commands may allow a user to instruct hardware components of a GPU 125 to execute commands without user knowledge as to the specifics of the hardware components. In order to process the graphics rendering instructions, CPU 110 may issue one or more rendering commands to GPU 125 (e.g., through GPU driver 120) to cause GPU 125 to perform some or all of the rendering of the graphics data. In some examples, the graphics data to be rendered may include a list of graphics primitives (e.g., points, lines, triangles, quadrilaterals, etc.).

The GPU program stored in system memory 140 may invoke or otherwise include one or more functions provided by GPU driver 120. CPU 110 generally executes the program in which the GPU program is embedded and, upon encountering the GPU program, passes the GPU program to GPU driver 120. CPU 110 executes GPU driver 120 in this context to process the GPU program. That is, for example, GPU driver 120 may process the GPU program by compiling the GPU program into object or machine code executable by GPU 125. This object code may be referred to as a locally-compiled GPU program. In some examples, a compiler associated with GPU driver 120 may operate in real-time or near-real-time to compile the GPU program during the execution of the program in which the GPU program is embedded. For example, the compiler may generally represent a unit that reduces HL instructions defined in accordance with a HL programming language to low-level (LL) instructions of a LL programming language. After compilation, these LL instructions are capable of being executed by specific types of processors or other types of hardware, such as FPGAs, ASICs, and the like (including, but not limited to, CPU 110 and GPU 125).

In the example of FIG. 1, the compiler may receive the GPU program from CPU 110 when executing HL code that includes the GPU program. That is, a software application being executed by CPU 110 may invoke GPU driver 120 (e.g., via a graphics API) to issue one or more commands to GPU 125 for rendering one or more graphics primitives into displayable graphics images. The compiler may compile the GPU program to generate the locally-compiled GPU program that conforms to a LL programming language. The compiler may then output the locally-compiled GPU program that includes the LL instructions. In some examples, the LL instructions may be provided to GPU 125 in the form a list of drawing primitives (e.g., triangles, rectangles, etc.).

The LL instructions (e.g., which may alternatively be referred to as primitive definitions) may include vertex specifications that specify one or more vertices associated with the primitives to be rendered. The vertex specifications may include positional coordinates for each vertex and, in some instances, other attributes associated with the vertex, such as color coordinates, normal vectors, and texture coordinates. The primitive definitions may include primitive type information, scaling information, rotation information, and the like. Based on the instructions issued by the software application (e.g., the program in which the GPU program is embedded), GPU driver 120 may formulate one or more commands that specify one or more operations for GPU 125 to perform in order to render the primitive.

When GPU 125 receives a command from CPU 110, it may decode the command and configure one or more processing elements to perform the specified operation and may output the rendered data to display buffer 135.

GPU 125 generally receives the locally-compiled GPU program, and then, in some instances, GPU 125 renders one or more images and outputs the rendered images to display buffer 135. For example, GPU 125 may generate a number of primitives to be displayed at display 145. Primitives may include one or more of a line (including curves, splines, etc.), a point, a circle, an ellipse, a polygon (e.g., a triangle), or any other two-dimensional primitive. The term “primitive” may also refer to three-dimensional primitives, such as cubes, cylinders, sphere, cone, pyramid, torus, or the like. Generally, the term “primitive” refers to any basic geometric shape or element capable of being rendered by GPU 125 for display as an image (or frame in the context of video data) via display 145. GPU 125 may transform primitives and other attributes (e.g., that define a color, texture, lighting, camera configuration, or other aspect) of the primitives into a so-called “world space” by applying one or more model transforms (which may also be specified in the state data). Once transformed, GPU 125 may apply a view transform for the active camera (which again may also be specified in the state data defining the camera) to transform the coordinates of the primitives and lights into the camera or eye space. GPU 125 may also perform vertex shading to render the appearance of the primitives in view of any active lights. GPU 125 may perform vertex shading in one or more of the above model, world, or view space.

Once the primitives are shaded, GPU 125 may perform projections to project the image into a canonical view volume. After transforming the model from the eye space to the canonical view volume, GPU 125 may perform clipping to remove any primitives that do not at least partially reside within the canonical view volume. That is, GPU 125 may remove any primitives that are not within the frame of the camera. GPU 125 may then map the coordinates of the primitives from the view volume to the screen space, effectively reducing the three-dimensional coordinates of the primitives to the two-dimensional coordinates of the screen. Given the transformed and projected vertices defining the primitives with their associated shading data, GPU 125 may then rasterize the primitives. Generally, rasterization may refer to the task of taking an image described in a vector graphics format and converting it to a raster image (e.g., a pixelated image) for output on a video display or for storage in a bitmap file format.

In some examples, GPU 125 may implement tile-based rendering to render an image. For example, GPU 125 may implement a tile-based architecture that renders an image or rendering target by breaking the image into multiple portions, referred to as tiles or bins. The bins may be sized based on the size of GPU memory 130 (e.g., which may alternatively be referred to herein as GMEM or a cache). When implementing tile-based rendering, GPU 125 may perform a binning pass and one or more rendering passes. For example, with respect to the binning pass, GPU 125 may process an entire image and sort rasterized primitives into bins. GPU 125 may also generate one or more visibility streams during the binning pass, which visibility streams may be separated according to bin. For example, each bin may be assigned a corresponding portion of the visibility stream for the image. GPU driver 120 may access the visibility stream and generate command streams for rendering each bin. In aspects of the following, a binning pass may alternatively be referred to as a visibility stream operation.

With respect to each rendering pass, GPU 125 may perform a load operation, a rendering operation, and/or a store operation. During the load operation, GPU 125 may initialize GPU memory 130 for a new bin to be rendered. During the rendering operation, GPU 125 may render the bin and store the rendered bin to GPU memory 130. That is, GPU 125 may perform pixel shading and other operations to determine pixel values for each pixel of the tile and write the pixel values to GPU memory 130. During the store operation, GPU 125 may transfer the finished pixel values of the bin from GPU memory 130 to display buffer 135 (or system memory 140). After GPU 125 has rendered all of the bins associated with a frame (e.g., or a given rendering target) in this way, display buffer 135 may output the finished image to display 145. In some cases, at least some of the bins may be rendered directly on system memory 140 (e.g., before being output to display buffer 135). That is, rather than being loaded from system memory 140 to the GMEM where the GPU 125 can quickly access and operate on the data before storing it to display buffer 135 or back to system memory 140, some bins may be operated on (e.g., by GPU 125) directly in system memory 140. In some such cases, the time (e.g., or processing power) saved by removing the load and store operations may outweigh the time lost by directly rendering in system memory 140 (e.g., rather than in a GMEM).

In accordance with the described techniques, a device such as device 100 may divide a frame or render target into an internal region and a boundary region. The internal region may comprise a portion of the frame or render target that may be divided into a plurality of bins such that no partial bins exist after bin subdivision within the internal region. In some examples, each bin of the internal region may have a size equal to (e.g., or nearly equal to) the size of the local memory, while in other examples at least some bins of the internal region may have a size different from the size of the local memory. The boundary region may comprise a remainder of the frame or render target that is not included in the internal region. The boundary region may be divided into bins in the horizontal direction, the vertical direction, or both to increase utilization of the local memory. By efficiently partitioning the frame or render target, the number of related operations (e.g., load and store operations, such as those by which GPU 125 loads bins to GPU memory 130 and stores rendered data to display buffer 135) associated with the rendering may be reduced, thereby improving rendering performance (e.g., by reducing power consumption without impacting the rendering quality). Additionally or alternatively, device 100 may perform direct rendering for at least some of the partially fragmented bins. Such direct rendering may remove the need to perform load and store operations for the partially fragmented bins (e.g., by allowing the device to render the bins directly on system memory 140).

In some examples, GPU 125 may provide dependency detection of one or more GPU workloads at device 100. For example, GPU 125 may provide efficient dependency detection for concurrent binning GPU workloads. In some cases, GPU 125 may generate one or more determined time durations, embed one or more determined time durations in each resource packet of a GPU workload, and identify the resource dependencies based at least in part on analysis performed after waiting for at least one of the one or more determined time durations to lapse.

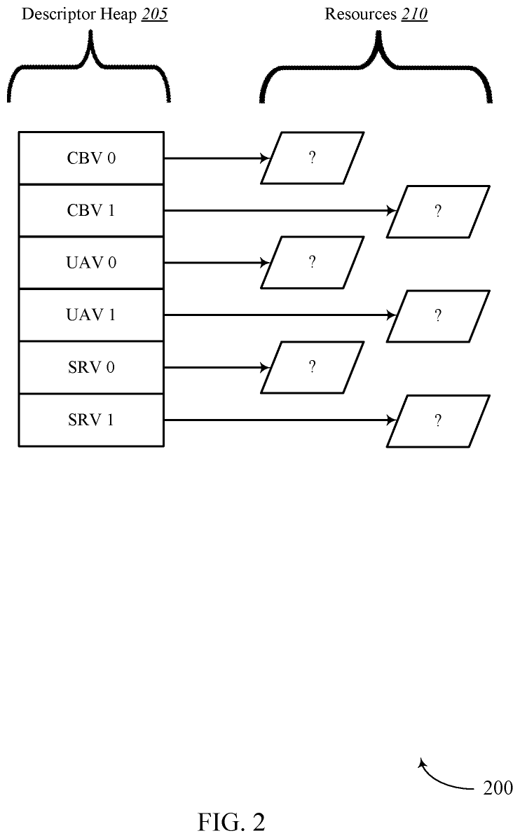

FIG. 2 illustrates an example of a GPU environment 200 that supports efficient dependency detection for concurrent binning GPU workloads in accordance with aspects of the present disclosure. In some examples, GPU environment 200 may implement aspects of device 100. In some cases, GPU environment 200 may include descriptor heap 205 and resources 210.

In some cases, the descriptor heap 205 may include one or more object types or resource descriptors that point to certain resources in memory (e.g., GPU memory 130, display buffer 135, CPU memory 115, and/or system memory 140). Resource descriptors may include non-bindless resource descriptors and/or bindless resource descriptors. Examples of non-bindless resource descriptors may include Render Target/Depth Stencil Views (RT/DSVs), Stream Out (SO), Vertex Buffer (VB), and Index Buffer resource descriptors, among others. Examples of bindless resource descriptors may include Constant Buffer Views (CBVs), Unordered Access Views (UAVs), Samplers, and/or Textures such as Shader Resource Views (SRVs), among others. In one example, a resource descriptor may be bindless since from the CPU side the resource descriptors may not be written yet when the draw/dispatch application program interface (API) is called from an application. Binding a resource descriptor may include a process of linking the resource descriptor or object to one or more shaders in a graphics pipeline.

As shown, GPU environment 200 may include descriptor heap 205 and resources 210. In some examples, descriptor heap 205 may include one or more resource descriptors such as Constant Buffer View 0 (CBV 0), CBV 1, Unordered Access View 0 (UAV 0), UAV 1, texture Shader Resource View 0 (SRV 0), and SRV 1, etc.

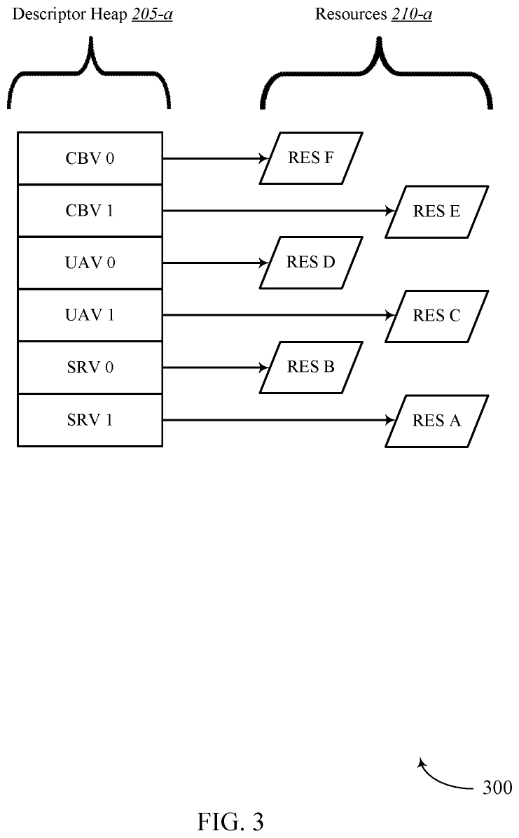

In some examples, a command processor of a GPU (e.g., command processor 150) may not be able to identify the location where certain resource descriptors are written (e.g., bindless resource descriptors). Thus, as shown, the command processor may not know the location where the resource descriptors of descriptor heap 205 are written (e.g., CBV 0, CBV 1, UAV 0, UAV 1, SRV 0, SRV 1, etc.). The present techniques, however, relate to identifying the location where the bindless descriptors are written, as described more in reference to FIG. 3.

FIG. 3 illustrates an example of a GPU environment 300 that supports efficient dependency detection for concurrent binning GPU workloads in accordance with aspects of the present disclosure. In some examples, GPU environment 300 may implement aspects of device 100. GPU environment 300 may be an example of GPU environment 200. As shown, GPU environment 200 may include descriptor heap 205-1 and resources 210-1. In one example, descriptor heap 205-a may be an example of descriptor heap 205 and resources 210-a may be an example of resources 210 from FIG. 2.

In some examples, by the time hardware (e.g., GPU 125, CPU 110, etc.) begins evaluating dependencies associated with descriptor heap 205-a, bindless descriptors may be written to memory, enabling a command processor (e.g., command processor 150) to identify the location where the bindless descriptors are written. As shown, a command processor may determine the location where the bindless descriptors of descriptor heap 205-a are written to memory. Thus, the command processor may determine where resource A of resources 210-a is written to memory, where resource B of resources 210-a is written to memory, where resource C of resources 210-a is written to memory, and so forth. Accordingly, the command processor may determine that SRV 1 is associated with resource A, SRV 0 is associated with resource B, UAV 1 is associated with resource C, and so on.

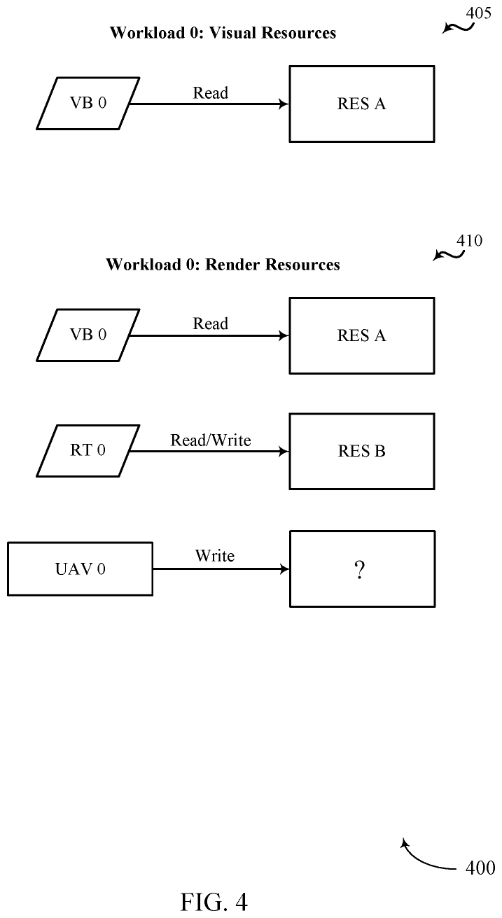

FIG. 4 illustrates an example of a GPU environment 400 that supports efficient dependency detection for concurrent binning GPU workloads in accordance with aspects of the present disclosure. In some examples, GPU environment 400 may implement aspects of device 100. GPU environment 400 may be an example of GPU environment 200 and/or 300. As shown, GPU environment 400 may include visual resources 405 and render resources 410. As illustrated, visual resources 405 and render resources 410 may be associated with a first workload of a GPU (e.g., Workload 0 as illustrated).

As illustrated, visual resource 405 may include a read of resource A by vertex buffer 0 (VB 0). Similarly, render resources 410 may include a read of resource A by VB 0, a read and a write of resource B by Render Target 0 (RT 0), and a write to an unknown location by unordered access view 0 (UAV 0). In order to process render resources 410, a command processor of a GPU (e.g., command processor 150) may first determine the location where the bindless descriptor associated with UAV 0 is written to memory. Further operations associated with determining the location where the bindless descriptor associated with UAV 0 is written to memory are described herein.

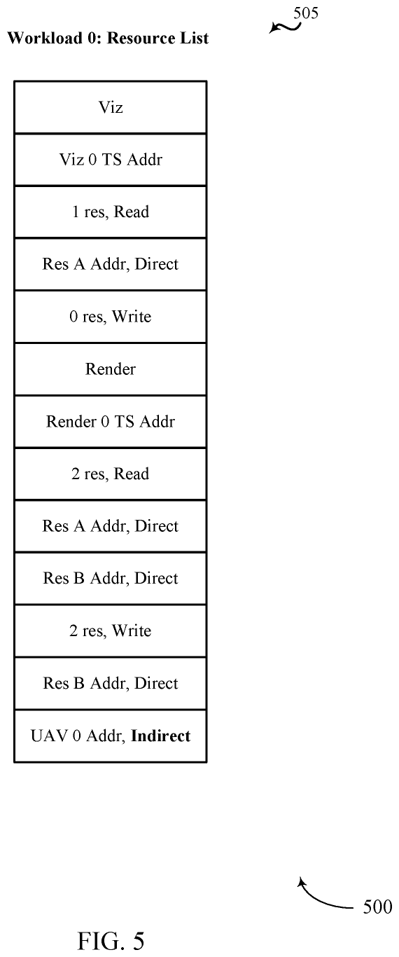

FIG. 5 illustrates an example of a GPU environment 500 that supports efficient dependency detection for concurrent binning GPU workloads in accordance with aspects of the present disclosure. In some examples, GPU environment 500 may implement aspects of device 100. GPU environment 500 may be an example of GPU environment 200, 300, and/or 400. As shown, GPU environment 500 may include resource list 505 of workload 0.

Resource list 505 may include a visual resource section that may include a visual header field Viz, an address of a duration timestamp of the visual resources (Viz 0 TS Addr), a count of visual resources being read from (1 res, Read), address of visual resources (Res A Addr, Direct), a count of write resources (0 res, Write), a render header field (Render), an address of a duration timestamp of the render resources (Render 0 TS Addr), a count of render resources being read from (2 res, Read), addresses of render resources being written to (Res A Addr, Direct; Res B Addr, Direct), a count of render resources being written to (2 res, Write), and addresses of render resources being read from (Res B Addr, Direct; UAV 0 Addr, Indirect).

As shown, resource list 505 includes a single visual resource (e.g., “1 res, Read”). As shown, this single visual resource is a direct resource, meaning that the location where this resource descriptor is written, or the location from which data for the resource will be read as a visual resource, is known and directly addressable. As shown, resource list 505 includes 2 render resources to be read (2 res, Read), and 2 render resources that will be written (2 res, Write), where one of the read render resources is the same as one of the write render resources (Res B Addr, Direct). Each of these render resources are also direct resources, meaning that the location from/to which data for the resource will be read or written is known and directly addressable. However, one of the render resources of resource list 505 is shown to be indirect (UAV 0 Addr, Indirect), meaning that the location where the resource descriptor of UAV 0 is written is indirectly addressable and not yet known because the CPU side of the resource descriptors may not be written yet when the draw/dispatch API is called from an application. In some cases, a command processor (e.g., command processor 150) may generate one or more read lists and/or write lists from a resource list (e.g., resource list 505). In some cases, command processor may use the one or more read lists and/or write lists to detect dependencies and wait for dependencies to be resolved.

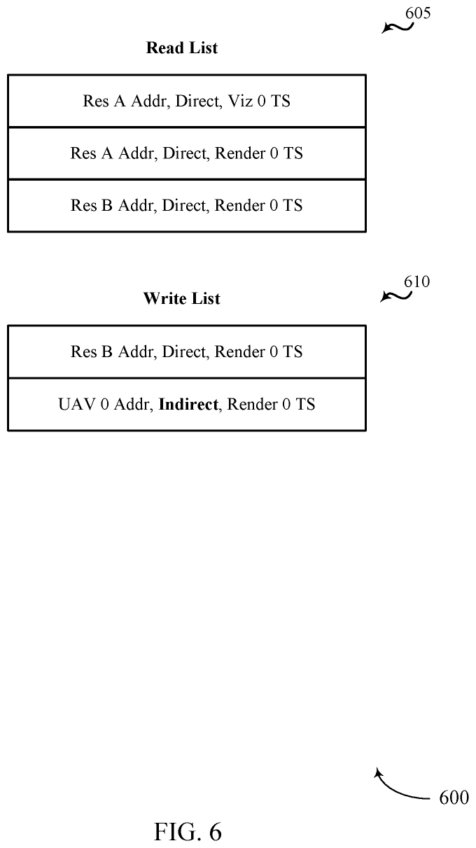

FIG. 6 illustrates an example of a GPU environment 600 that supports efficient dependency detection for concurrent binning GPU workloads in accordance with aspects of the present disclosure. In some examples, GPU environment 600 may implement aspects of device 100. GPU environment 600 may be an example of GPU environment 200, 300, 400, and/or 500. As shown, GPU environment 600 may include read list 605 and write list 610. In one example, read list 605 may include a list of resources being read from memory. In some embodiment, read list 605 may be generated based on the information included in resource list 505. Additionally or alternatively, write list 610 may be generated based on the information included in resource list 505.

As shown, a first entry of read list 605 may include an address to resource A that may indicate the address from which the resource is to be read is direct and is associated with a determined time duration of the workload 0 visual resources; a second entry of read list 605 may include an address to resource A that may indicate the address from which the resource is to be read is direct and associated with a determined time duration of the workload 0 render resources; a third entry of read list 605 may include an address to resource B that may indicate the address from which the resource is to be read is direct and associated with the determined time duration of the workload 0 render resources. As indicated above, the fields of read list 605 may be generated based at least in part on information from resource list 505. For example, the visual timestamp field (Viz 0 TS Addr) and read resource field (Res A Addr, Direct) from resource list 505 may be used to populate a field of read list 605 (e.g., Res A Addr, Direct, Viz 0 TS).

Also shown, a first entry of write list 610 may include an address to resource B that may indicate the address to which the resource is to be written is direct and associated with the determined time duration of the workload 0 render resources; and a second entry of write list 610 may include an address to UAV 0 that may indicate the address to which the resource is to be written is indirect and associated with the determined time duration of the workload 0 render resources.

In one example, each workload or level 1 indirect buffer (IB1) may create two lists of entries for resource descriptors, one for read and one for write (e.g., read list 605 and write list 610). In order to efficiently detect dependencies of concurrent binning workloads, software may submit a list of read and written resources for a given workload for a given number of passes that could occur during that workload along with a determined time duration for each pass that may be waited on to ensure that the actions in that pass have completed. In some cases, these determined durations of time may be referred to as timestamps or duration timestamps.

In order to efficiently detect dependencies of concurrent binning workloads, a command processor (e.g., command processor 150) may submit a list of data read and/or data write resources for a given workload for a given number of passes that may occur in that workload, together with a determined time duration for each pass that may be waited on to ensure that the actions in that pass have completed. The advantage to this solution is reduced driver overhead while also reducing bubbles (e.g., rendering delays) that could occur from software performing inefficient stalls to satisfy dependencies. In some embodiments, each entry outlines information regarding the resource for the workload, e.g. the associated GPU address.

When a resource is bindless, instead of directly providing the GPU address of the resource (which may be unknown at record time), a GPU address to a memory location containing the base GPU address of the resource may be provided. In some cases, along with the list of entries, two GPU addresses may be provided, such as an address to a resource and an address to a memory location where a determined duration is written. In some cases, the address may include a pointer to a memory location where the determined duration is written. In some cases, memory may be initialized to 0 when created the determined duration is created.

With a list of read resources and a list of write resources provided by User-Mode Graphics Driver (UMD) per pass per workload, the command processor can more easily handle detecting dependencies and wait for dependencies to be resolved. In some cases, when the number of resources provided exceeds a determined threshold, the command processor may wait on a determined duration of a current workload and clear all memory locations associated with workloads preceding the current workload.

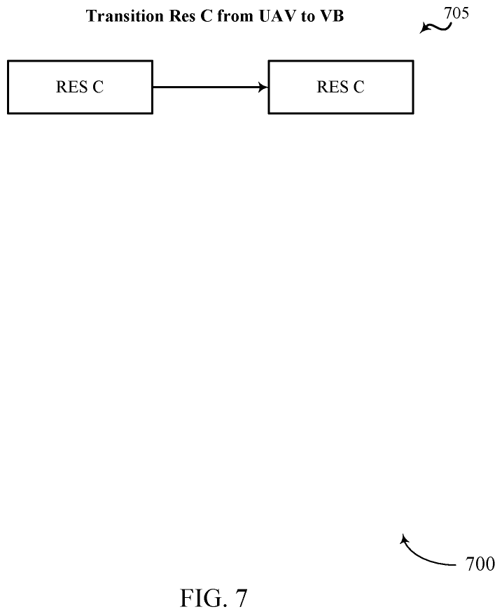

FIG. 7 illustrates an example of a GPU environment 700 that supports efficient dependency detection for concurrent binning GPU workloads in accordance with aspects of the present disclosure. In some examples, GPU environment 700 may implement aspects of device 100. GPU environment 700 may be an example of GPU environment 200, 300, 400, 500, and/or 600.

As shown, a command processor (e.g., command processor 150) may determine that UAV 0 of workload 0 render resources (e.g., UAV 0 of FIGS. 4, 5, and/or 6) may be associated with resource C. In some cases, the command processor may transition UAV 0 from an Unordered Access View (i.e., a bindless resource descriptor) to a Vertex Buffer (i.e., a non-bindless resource descriptor). Accordingly, the command processor may determine the dependency of resource C between workload 0 and a subsequent, related workload 1.

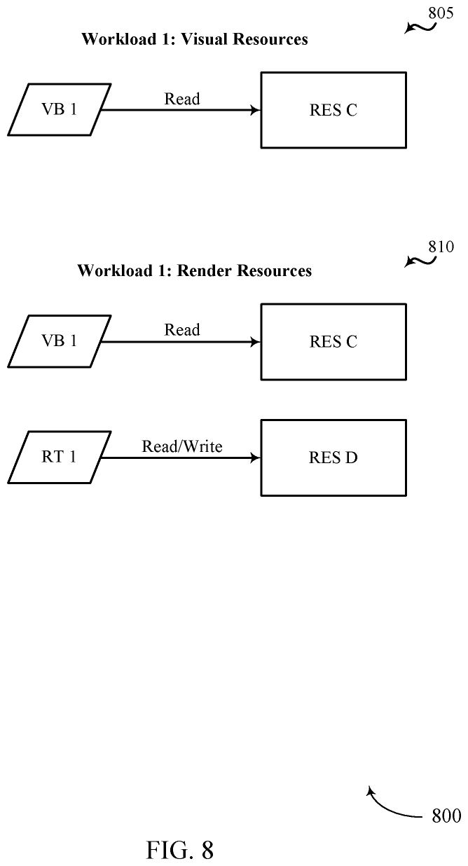

FIG. 8 illustrates an example of a GPU environment 800 that supports efficient dependency detection for concurrent binning GPU workloads in accordance with aspects of the present disclosure. In some examples, GPU environment 800 may implement aspects of device 100. GPU environment 800 may be an example of GPU environment 200, 300, 400, 500, 600, and/or 700. As shown, GPU environment 800 may include visual resources 805 of a workload dependent on workload 0 (e.g., workload 1) and render resources 810 of the same workload 1 that is dependent on resources from workload 0.

As illustrated, visual resource 805 may include a read of resource C by vertex buffer 1 (VB 1). Similarly, render resources 810 may include a read of resource C by VB 1, a read and a write of resource D by Render Target 1 (RT 1). In order to process render resources 810, a command processor of a GPU (e.g., command processor 150) may have previously determined the location where one or more bindless descriptors associated are written to memory (e.g., UAV 0) and a command processor of a GPU may then generate a resource list based on the identified visual resources (e.g., visual resource 805) and the identified render resources (e.g., render resources 810).

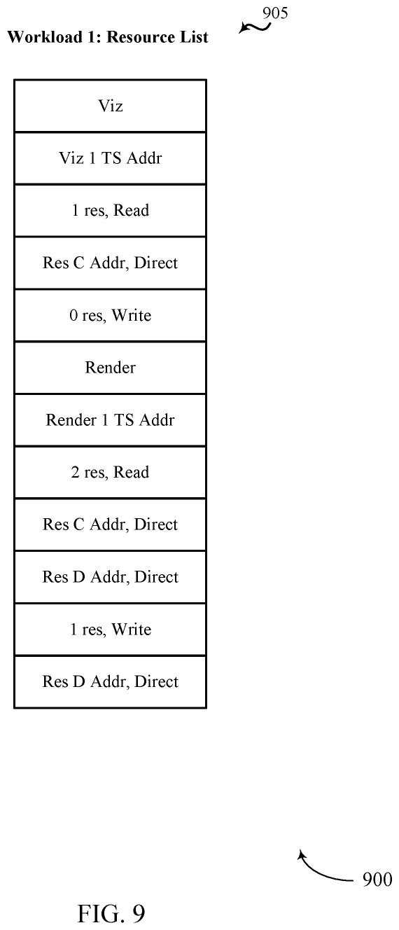

FIG. 9 illustrates an example of a GPU environment 900 that supports efficient dependency detection for concurrent binning GPU workloads in accordance with aspects of the present disclosure. In some examples, GPU environment 900 may implement aspects of device 100. GPU environment 900 may be an example of GPU environment 200, 300, 400, 500, 600, 700, and/or 800. As shown, GPU environment 900 may include resource list 905 of workload 1.

Resource list 905 may include a visual resource section that may include a visual header field (Viz), an address of a duration timestamp of the visual resource (Viz 0 TS Addr), a count of visual resources being read from (1 res, Read), address of visual resources being read (Res A Addr, Direct), a count of visual resources being written to (0 res, Write), a render header field (Render), an address of a duration timestamp of the render resources (Render 0 TS Addr), a count of read resources (2 res, Read), addresses of render resources being written to (Res A Addr, Direct; Res B Addr, Direct), a count of write resources (2 res, Write), and addresses of render resources being read from (Res B Addr, Direct; UAV 0 Addr, Indirect).

As shown, resource list 905 may include a list of resources used in workload 1. In one embodiment, all of the visual resources of resource list 905 may be direct (Res C Addr, Direct (visual read)), meaning that the location where these visual resource descriptors are written is known and directly addressable. Similarly, each of the render resources of resource list 905 may be direct (Res C Addr, Direct (render read); Res D Addr, Direct (render read/write)), meaning that the location where these render resource descriptors are written is known and directly addressable.

In some embodiments, the resources used in a resource list of a subsequent workload (e.g., resource list 905 of workload 1) may depend on one or more resources from a resource list of a previous workload (e.g., resource list 505 of workload 0). In some cases, at least one of the resources from the previous workload may be an indirect resource (e.g., UAV 0 from resource list 505 of workload 0). Accordingly, an associated command processor (e.g., command processor 150) may be configured to identify one or more indirect resources from a first workload (e.g., workload 0), transition the one or more indirect resources to direct resources, and provide the one or more indirect-to-direct transitioned resources to subsequent workloads (e.g., workload 1) to improve a rendering performance of a GPU system.

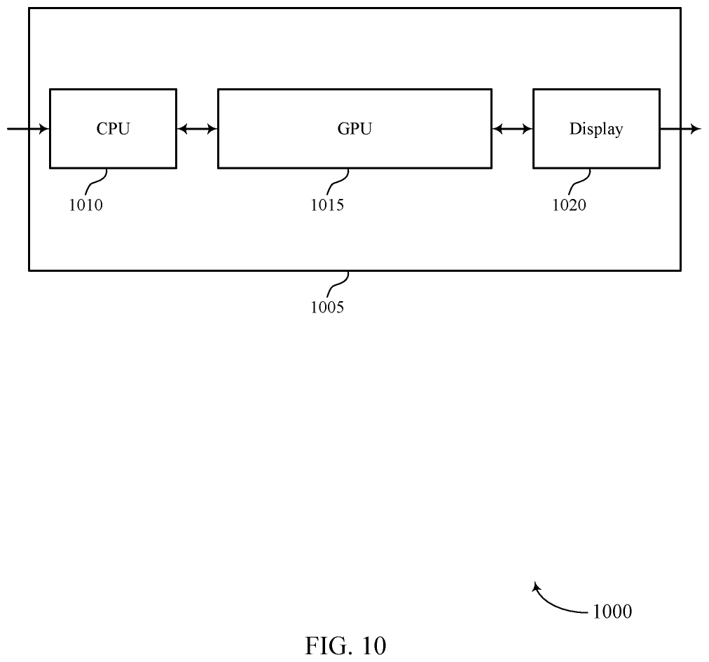

FIG. 10 shows a block diagram 1000 of a device 1005 that supports efficient dependency detection for concurrent binning GPU workloads in accordance with aspects of the present disclosure. The device 1005 may be an example of aspects of a device as described herein. The device 1005 may include a central processing unit (CPU) 1010, a GPU 1015, and a display 1020. The device 1005 may also include a processor. Each of these components may be in communication with one another (e.g., via one or more buses).

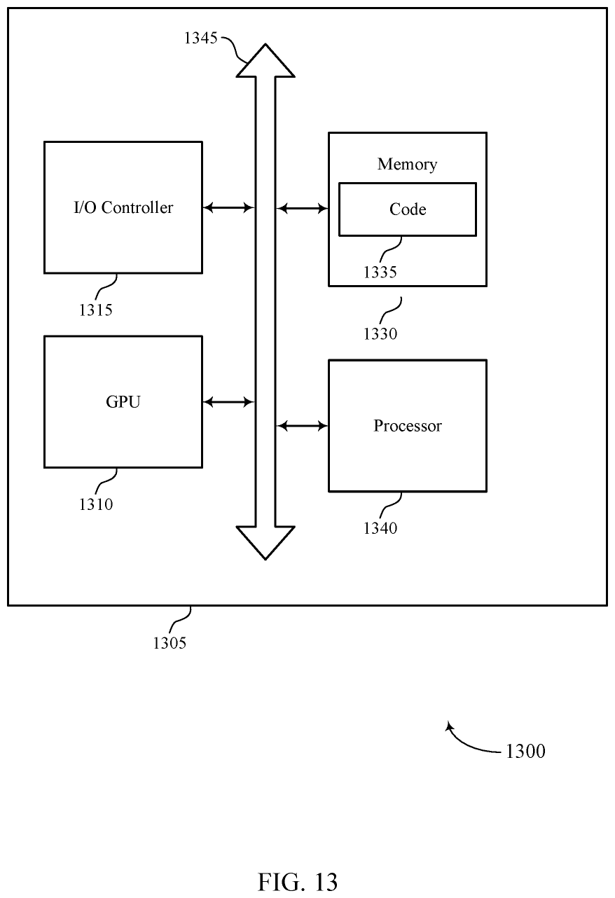

The CPU 1010 may receive information such as packets, user data, or control information associated with various information channels (e.g., control channels, data channels, and information related to efficient dependency detection for concurrent binning GPU workloads, etc.). Information may be passed on to other components of the device 1005. The CPU 1010 may be an example of aspects of the transceiver 1320 described with reference to FIG. 13. The CPU 1010 may utilize a single antenna or a set of antennas.

The GPU 1015 may generate a resource packet for a first GPU workload of a set of GPU workloads, the resource packet including a list of resources, identify a first resource from the list of resources, retrieve a GPU address from a first memory location associated with the first resource, determine whether a dependency of the first resource exists between the first GPU workload and a second GPU workload from the set of GPU workloads based on the retrieving of the GPU address, and process, when the dependency exists, the first resource after waiting for a duration to lapse. The GPU 1015 may be an example of aspects of the GPU 125, 1115, 1205, and/or 1310 described herein.

The GPU 1015, or its sub-components, may be implemented in hardware, code (e.g., software or firmware) executed by a processor, or any combination thereof. If implemented in code executed by a processor, the functions of the GPU 1015, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The GPU 1015, or its sub-components, may be physically located at various positions, including being distributed such that portions of functions are implemented at different physical locations by one or more physical components. In some examples, the GPU 1015, or its sub-components, may be a separate and distinct component in accordance with various aspects of the present disclosure. In some examples, the GPU 1015, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The display 1020 may transmit signals generated by other components of the device 1005. In some examples, the display 1020 may be collocated with a CPU 1010 in a transceiver module. For example, the display 1020 may be an example of aspects of the transceiver 1320 described with reference to FIG. 13. The display 1020 may utilize a single antenna or a set of antennas.

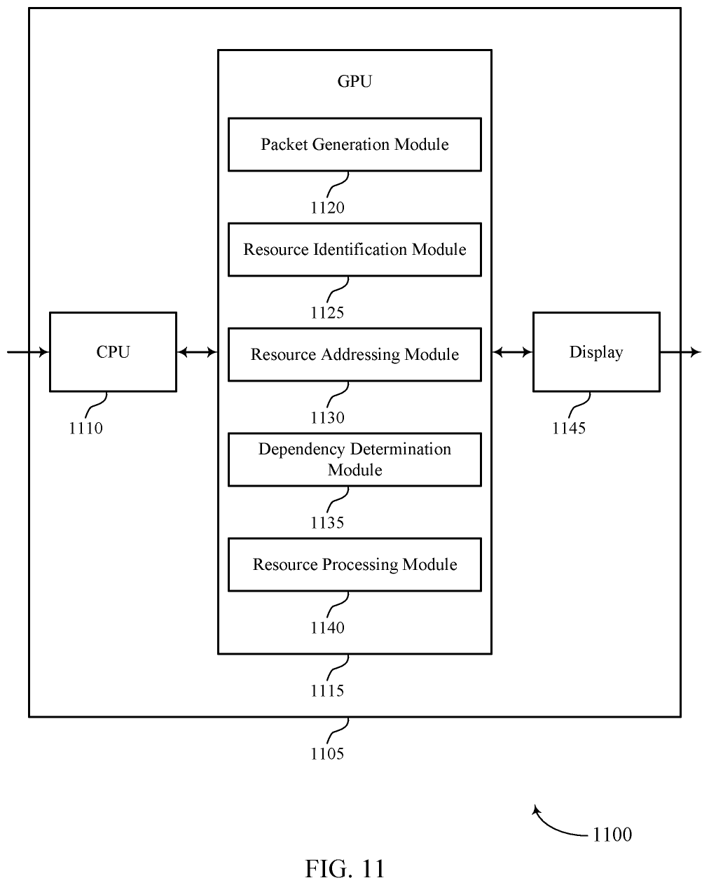

FIG. 11 shows a block diagram 1100 of a device 1105 that supports efficient dependency detection for concurrent binning GPU workloads in accordance with aspects of the present disclosure. The device 1105 may be an example of aspects of a device 1005 or a cpu memory 115 as described herein. The device 1105 may include a CPU 1110, a GPU 1115, and a display 1145. The device 1105 may also include a processor. Each of these components may be in communication with one another (e.g., via one or more buses).

The CPU 1110 may receive information such as packets, user data, or control information associated with various information channels (e.g., control channels, data channels, and information related to efficient dependency detection for concurrent binning GPU workloads, etc.). Information may be passed on to other components of the device 1105. The CPU 1110 may be an example of aspects of the transceiver 1320 described with reference to FIG. 13. The CPU 1110 may utilize a single antenna or a set of antennas.

The GPU 1115 may be an example of aspects of the GPU 1015 as described herein. The GPU 1115 may include a packet generation module 1120, a resource identification module 1125, a resource addressing module 1130, a dependency determination module 1135, and a resource processing module 1140. The GPU 1115 may be an example of aspects of the GPU 1310 described herein.

The packet generation module 1120 may generate a resource packet for a first GPU workload of a set of GPU workloads. In some cases, the resource packet may include a list of resources. The resource identification module 1125 may identify a first resource from the list of resources. The resource addressing module 1130 may retrieve a GPU address from a first memory location associated with the first resource.

The dependency determination module 1135 may determine whether a dependency of the first resource exists between the first GPU workload and a second GPU workload from the set of GPU workloads based on the retrieving of the GPU address. The resource processing module 1140 may process, when the dependency exists, the first resource after waiting for a duration to lapse.

The display 1145 may transmit signals generated by other components of the device 1105. In some examples, the display 1145 may be collocated with a CPU 1110 in a transceiver module. For example, the display 1145 may be an example of aspects of the transceiver 1320 described with reference to FIG. 13. The display 1145 may utilize a single antenna or a set of antennas.

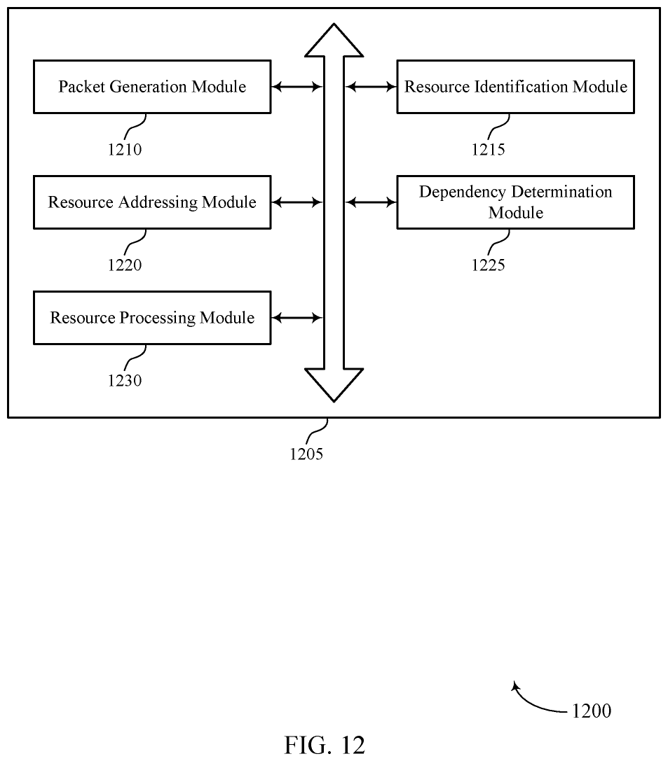

FIG. 12 shows a block diagram 1200 of a GPU 1205 that supports efficient dependency detection for concurrent binning GPU workloads in accordance with aspects of the present disclosure. The GPU 1205 may be an example of aspects of a GPU 1015, a GPU 1115, or a GPU 1310 described herein. The GPU 1205 may include a packet generation module 1210, a resource identification module 1215, a resource addressing module 1220, a dependency determination module 1225, and a resource processing module 1230. Each of these modules may communicate, directly or indirectly, with one another (e.g., via one or more buses).

The packet generation module 1210 may generate a resource packet for a first GPU workload of a set of GPU workloads. In some cases, the resource packet may include a list of resources. In some examples, the packet generation module 1210 may generate the resource packet using a GPU device driver.

In some examples, the packet generation module 1210 may generate at least one resource packet for each of the set of GPU workloads. The resource identification module 1215 may identify a first resource from the list of resources.

In some examples, the resource identification module 1215 may identify the first resource as a bindless resource based on the retrieving of the GPU address, where determining whether the dependency of the first resource exists between the first GPU workload and the second GPU workload is based on the first resource being identified as a bindless resource.

In some examples, the resource identification module 1215 may identify a second resource from the list of resources as a non-bindless resource. The resource addressing module 1220 may retrieve a GPU address from a first memory location associated with the first resource. In some examples, the resource addressing module 1220 may identify a GPU address of the second resource provided in the resource packet.

In some examples, the resource addressing module 1220 may provide the GPU address of the second resource directly to a GPU without waiting for the duration to lapse. In some cases, the GPU address includes a pointer to a second memory location containing a base GPU address of the first resource. In some cases, the first memory location, or the second memory location, or both, include a pointer to a third memory location where a countdown value of the duration is stored.

The dependency determination module 1225 may determine whether a dependency of the first resource exists between the first GPU workload and a second GPU workload from the set of GPU workloads based on the retrieving of the GPU address. The resource processing module 1230 may process, when the dependency exists, the first resource after waiting for a duration to lapse. In some examples, the resource processing module 1230 may process the first resource without waiting for the duration to lapse when the dependency does not exist.

In some examples, the resource processing module 1230 may determine that a number of resources provided in the first GPU workload satisfies a determined resource threshold. In some examples, the resource processing module 1230 may wait on a current duration. In some examples, the resource processing module 1230 may clear at least one memory location associated with a third GPU workload that finishes before the first GPU workload finishes.

In some cases, the list of resources includes a list of read resources and a list of write resources. In some cases, the list of resources includes entries for resource descriptors of resources being read or written during the first GPU workload. In some cases, at least one of the set of GPU workloads includes a concurrent binning GPU workload, or a level 1 indirect buffer (IB1) workload, or both.

FIG. 13 shows a diagram of a system 1300 including a device 1305 that supports efficient dependency detection for concurrent binning GPU workloads in accordance with aspects of the present disclosure. The device 1305 may be an example of or include the components of device 1005, device 1105, or a device as described herein. The device 1305 may include components for bi-directional voice and data communications including components for transmitting and receiving communications, including a GPU 1310, an I/O controller 1315, memory 1330, and a processor 1340. These components may be in electronic communication via one or more buses (e.g., bus 1345).

The GPU 1310 may generate a resource packet for a first GPU workload of a set of GPU workloads, the resource packet including a list of resources, identify a first resource from the list of resources, retrieve a GPU address from a first memory location associated with the first resource, determine whether a dependency of the first resource exists between the first GPU workload and a second GPU workload from the set of GPU workloads based on the retrieving of the GPU address, and process, when the dependency exists, the first resource after waiting for a duration to lapse.

The I/O controller 1315 may manage input and output signals for the device 1305. The I/O controller 1315 may also manage peripherals not integrated into the device 1305. In some cases, the I/O controller 1315 may represent a physical connection or port to an external peripheral. In some cases, the I/O controller 1315 may utilize an operating system such as iOS®, ANDROID®, MS-DOS®, MS-WINDOWS®, OS/2®, UNIX®, LINUX®, or another known operating system. In other cases, the I/O controller 1315 may represent or interact with a modem, a keyboard, a mouse, a touchscreen, or a similar device. In some cases, the I/O controller 1315 may be implemented as part of a processor. In some cases, a user may interact with the device 1305 via the I/O controller 1315 or via hardware components controlled by the I/O controller 1315.

The memory 1330 may include RAM and ROM. The memory 1330 may store computer-readable, computer-executable code 1335 including instructions that, when executed, cause the processor to perform various functions described herein. In some cases, the memory 1330 may contain, among other things, a BIOS which may control basic hardware or software operation such as the interaction with peripheral components or devices.

The processor 1340 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting efficient dependency detection for concurrent binning GPU workloads).

The code 1335 may include instructions to implement aspects of the present disclosure, including instructions to support dependency detection of a graphical processor unit (GPU) workload at a device. The code 1335 may be stored in a non-transitory computer-readable medium such as system memory or other type of memory. In some cases, the code 1335 may not be directly executable by the processor 1340 but may cause a computer (e.g., when compiled and executed) to perform functions described herein.

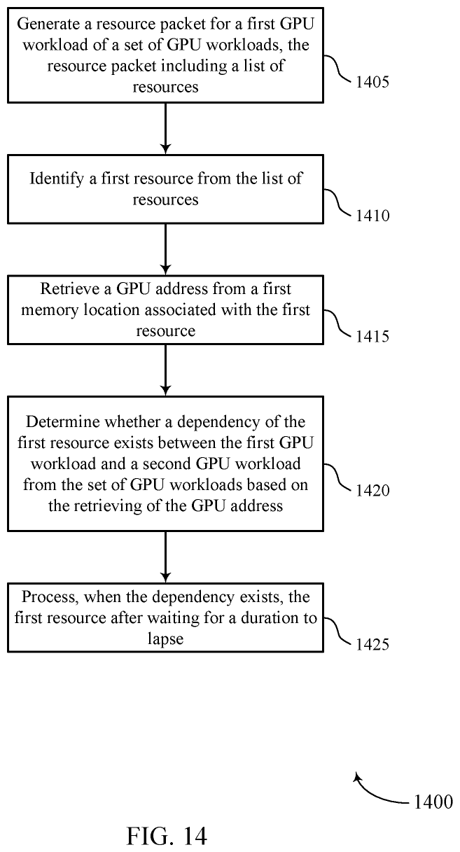

FIG. 14 shows a flowchart illustrating a method 1400 that supports efficient dependency detection for concurrent binning GPU workloads in accordance with aspects of the present disclosure. The operations of method 1400 may be implemented by a device or its components as described herein. For example, the operations of method 1400 may be performed by a GPU as described with reference to FIGS. 10 through 13. In some examples, a device may execute a set of instructions to control the functional elements of the device to perform the functions described below. Additionally or alternatively, a device may perform aspects of the functions described below using special-purpose hardware.

At 1405, the device may generate a resource packet for a first GPU workload of a set of GPU workloads. In some cases, the resource packet may include a list of resources. The operations of 1405 may be performed according to the methods described herein. In some examples, aspects of the operations of 1405 may be performed by a packet generation module as described with reference to FIGS. 10 through 13.

At 1410, the device may identify a first resource from the list of resources. The operations of 1410 may be performed according to the methods described herein. In some examples, aspects of the operations of 1410 may be performed by a resource identification module as described with reference to FIGS. 10 through 13.

At 1415, the device may retrieve a GPU address from a first memory location associated with the first resource. The operations of 1415 may be performed according to the methods described herein. In some examples, aspects of the operations of 1415 may be performed by a resource addressing module as described with reference to FIGS. 10 through 13.

At 1420, the device may determine whether a dependency of the first resource exists between the first GPU workload and a second GPU workload from the set of GPU workloads based on the retrieving of the GPU address. The operations of 1420 may be performed according to the methods described herein. In some examples, aspects of the operations of 1420 may be performed by a dependency determination module as described with reference to FIGS. 10 through 13.

At 1425, the device may process, when the dependency exists, the first resource after waiting for a duration to lapse. The operations of 1425 may be performed according to the methods described herein. In some examples, aspects of the operations of 1425 may be performed by a resource processing module as described with reference to FIGS. 10 through 13.

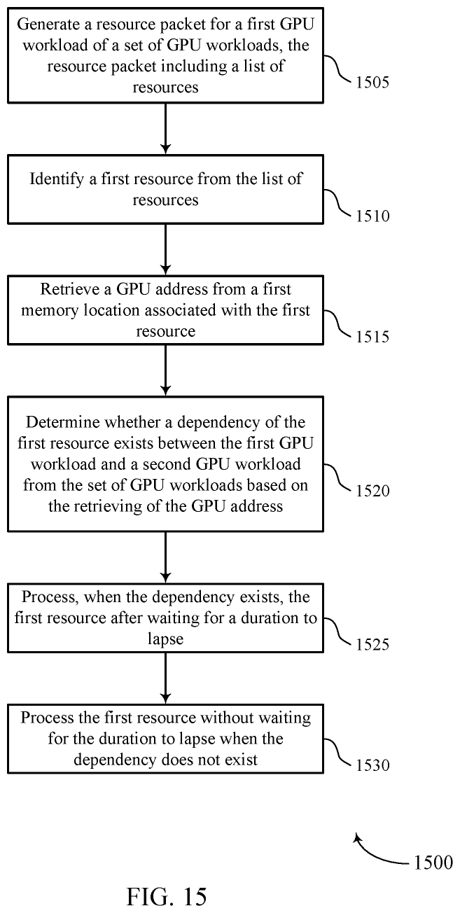

FIG. 15 shows a flowchart illustrating a method 1500 that supports efficient dependency detection for concurrent binning GPU workloads in accordance with aspects of the present disclosure. The operations of method 1500 may be implemented by a device or its components as described herein. For example, the operations of method 1500 may be performed by a GPU as described with reference to FIGS. 10 through 13. In some examples, a device may execute a set of instructions to control the functional elements of the device to perform the functions described below. Additionally or alternatively, a device may perform aspects of the functions described below using special-purpose hardware.

At 1505, the device may generate a resource packet for a first GPU workload of a set of GPU workloads. In some cases, the resource packet may include a list of resources. The operations of 1505 may be performed according to the methods described herein. In some examples, aspects of the operations of 1505 may be performed by a packet generation module as described with reference to FIGS. 10 through 13.

At 1510, the device may identify a first resource from the list of resources. The operations of 1510 may be performed according to the methods described herein. In some examples, aspects of the operations of 1510 may be performed by a resource identification module as described with reference to FIGS. 10 through 13.

At 1515, the device may retrieve a GPU address from a first memory location associated with the first resource. The operations of 1515 may be performed according to the methods described herein. In some examples, aspects of the operations of 1515 may be performed by a resource addressing module as described with reference to FIGS. 10 through 13.

At 1520, the device may determine whether a dependency of the first resource exists between the first GPU workload and a second GPU workload from the set of GPU workloads based on the retrieving of the GPU address. The operations of 1520 may be performed according to the methods described herein. In some examples, aspects of the operations of 1520 may be performed by a dependency determination module as described with reference to FIGS. 10 through 13.

At 1525, the device may process, when the dependency exists, the first resource after waiting for a duration to lapse. The operations of 1525 may be performed according to the methods described herein. In some examples, aspects of the operations of 1525 may be performed by a resource processing module as described with reference to FIGS. 10 through 13.

At 1530, the device may process the first resource without waiting for the duration to lapse when the dependency does not exist. The operations of 1530 may be performed according to the methods described herein. In some examples, aspects of the operations of 1530 may be performed by a resource processing module as described with reference to FIGS. 10 through 13.

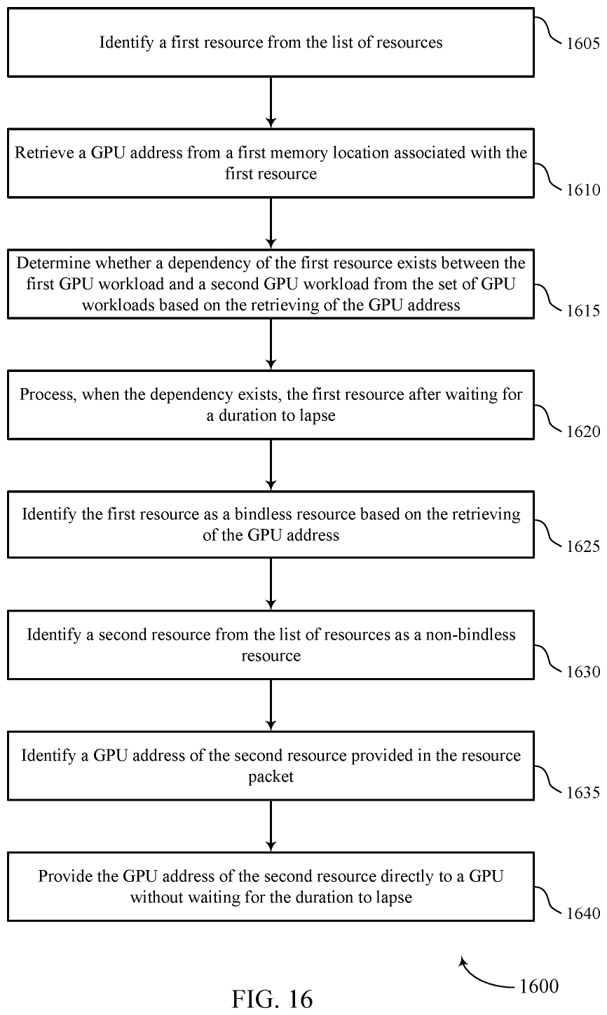

FIG. 16 shows a flowchart illustrating a method 1600 that supports efficient dependency detection for concurrent binning GPU workloads in accordance with aspects of the present disclosure. The operations of method 1600 may be implemented by a device or its components as described herein. For example, the operations of method 1600 may be performed by a GPU as described with reference to FIGS. 10 through 13. In some examples, a device may execute a set of instructions to control the functional elements of the device to perform the functions described below. Additionally or alternatively, a device may perform aspects of the functions described below using special-purpose hardware.

At 1605, the device may identify a first resource from a list of resources based at least in part on the method 1600 generating a resource packet for a first GPU workload of a set of GPU workloads. In some cases, the resource packet may include a list of resources. The operations of 1605 may be performed according to the methods described herein. In some examples, aspects of the operations of 1605 may be performed by a packet generation module as described with reference to FIGS. 10 through 13.

At 1610, the device may retrieve a GPU address from a first memory location associated with the first resource. The operations of 1610 may be performed according to the methods described herein. In some examples, aspects of the operations of 1610 may be performed by a resource addressing module as described with reference to FIGS. 10 through 13.

At 1615, the device may determine whether a dependency of the first resource exists between the first GPU workload and a second GPU workload from the set of GPU workloads based on the retrieving of the GPU address. The operations of 1615 may be performed according to the methods described herein. In some examples, aspects of the operations of 1615 may be performed by a dependency determination module as described with reference to FIGS. 10 through 13.

At 1620, the device may process, when the dependency exists, the first resource after waiting for a duration to lapse. The operations of 1620 may be performed according to the methods described herein. In some examples, aspects of the operations of 1620 may be performed by a resource processing module as described with reference to FIGS. 10 through 13.

At 1625, the device may identify the first resource as a bindless resource based on the retrieving of the GPU address, where determining whether the dependency of the first resource exists between the first GPU workload and the second GPU workload is based on the first resource being identified as a bindless resource. The operations of 1625 may be performed according to the methods described herein. In some examples, aspects of the operations of 1625 may be performed by a resource identification module as described with reference to FIGS. 10 through 13.

At 1630, the device may identify a second resource from the list of resources as a non-bindless resource. The operations of 1630 may be performed according to the methods described herein. In some examples, aspects of the operations of 1630 may be performed by a resource identification module as described with reference to FIGS. 10 through 13.

At 1635, the device may identify a GPU address of the second resource provided in the resource packet. The operations of 1635 may be performed according to the methods described herein. In some examples, aspects of the operations of 1635 may be performed by a resource addressing module as described with reference to FIGS. 10 through 13.

At 1640, the device may provide the GPU address of the second resource directly to a GPU without waiting for the duration to lapse. The operations of 1640 may be performed according to the methods described herein. In some examples, aspects of the operations of 1640 may be performed by a resource addressing module as described with reference to FIGS. 10 through 13.

It should be noted that the methods described above describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for dependency detection of a graphical processor unit (GPU) workload at a device, comprising:
generating a resource packet for a first GPU workload of a plurality of GPU workloads, the resource packet including a list of resources;
identifying a first resource from the list of resources;
retrieving a GPU address from a first memory location associated with the first resource;
determining whether a dependency of the first resource exists between the first GPU workload and a second GPU workload from the plurality of GPU workloads based at least in part on the retrieving of the GPU address; and
processing, when the dependency exists, the first resource after waiting for a duration to lapse.

2. The method of claim 1, further comprising:
processing the first resource without waiting for the duration to lapse when the dependency does not exist.

3. The method of claim 1, further comprising:
identifying the first resource as a bindless resource based at least in part on the retrieving of the GPU address, wherein determining whether the dependency of the first resource exists between the first GPU workload and the second GPU workload is based at least in part on the first resource being identified as a bindless resource.

4. The method of claim 1, further comprising:
identifying a second resource from the list of resources as a non-bindless resource.

5. The method of claim 4, further comprising:
identifying a GPU address of the second resource provided in the resource packet; and
providing the GPU address of the second resource directly to a GPU without waiting for the duration to lapse.

6. The method of claim 1, wherein the list of resources includes a list of read resources and a list of write resources.

7. The method of claim 1, wherein the list of resources includes entries for resource descriptors of resources being read or written during the first GPU workload.

8. The method of claim 1, wherein generating the resource packet comprises:
generating the resource packet using a GPU device driver.

9. The method of claim 1, further comprising:
determining that a number of resources provided in the first GPU workload satisfies a determined resource threshold;
waiting on a current duration; and
clearing at least one memory location associated with a third GPU workload that finishes before the first GPU workload finishes.

10. The method of claim 1, wherein the GPU address comprises a pointer to a second memory location containing a base GPU address of the first resource.

11. The method of claim 1, wherein the first memory location, or the second memory location, or both, comprise a pointer to a third memory location where a countdown value of the duration is stored.

12. The method of claim 1, wherein at least one of the plurality of GPU workloads includes a concurrent binning GPU workload, or a level 1 indirect buffer (IB1) workload, or both.

13. The method of claim 1, further comprising:
generating at least one resource packet for each of the plurality of GPU workloads.

14. An apparatus for dependency detection of a graphical processor unit (GPU) workload, comprising:
a processor,
memory in electronic communication with the processor; and
instructions stored in the memory and executable by the processor to cause the apparatus to:
generate a resource packet for a first GPU workload of a plurality of GPU workloads, the resource packet including a list of resources;
identify a first resource from the list of resources;
retrieve a GPU address from a first memory location associated with the first resource;
determine whether a dependency of the first resource exists between the first GPU workload and a second GPU workload from the plurality of GPU workloads based at least in part on the retrieving of the GPU address; and
process, when the dependency exists, the first resource after waiting for a duration to lapse.

15. The apparatus of claim 14, wherein the instructions are further executable by the processor to cause the apparatus to:
process the first resource without waiting for the duration to lapse when the dependency does not exist.

16. The apparatus of claim 14, wherein the instructions are further executable by the processor to cause the apparatus to:
identify the first resource as a bindless resource based at least in part on the retrieving of the GPU address, wherein determining whether the dependency of the first resource exists between the first GPU workload and the second GPU workload is based at least in part on the first resource being identified as a bindless resource.

17. The apparatus of claim 14, wherein the instructions are further executable by the processor to cause the apparatus to:
identify a second resource from the list of resources as a non-bindless resource.

18. The apparatus of claim 17, wherein the instructions are further executable by the processor to cause the apparatus to:
identify a GPU address of the second resource provided in the resource packet; and
provide the GPU address of the second resource directly to a GPU without waiting for the duration to lapse.

19. A non-transitory computer-readable medium storing code for dependency detection of a graphical processor unit (GPU) workload at a device, the code comprising instructions executable by a processor to:
generate a resource packet for a first GPU workload of a plurality of GPU workloads, the resource packet including a list of resources;
identify a first resource from the list of resources;
retrieve a GPU address from a first memory location associated with the first resource;
determine whether a dependency of the first resource exists between the first GPU workload and a second GPU workload from the plurality of GPU workloads based at least in part on the retrieving of the GPU address; and
process, when the dependency exists, the first resource after waiting for a duration to lapse.

20. The non-transitory computer-readable medium of claim 19, wherein the instructions are further executable to:
process the first resource without waiting for the duration to lapse when the dependency does not exist.
